(19) United States
(12) Patent Application Publication
(10) Pub. No.: US 2014/0081726 A1
(43) Pub. Date: Mar. 20, 2014

(54) METHOD AND SYSTEM FOR SOCIAL NETWORK INITIATED REWARDS

(71) Applicant: MASTERCAR INTERNATIONAL INCORPORATED, Purchase, NY (US)

(72) Inventors: Alan COOKE, Dublin (IE); Adam Kenneth HOSP, Lake St. Louis, MO (US); Stephen WHITNEY, Dublin (IE); J. Chris WHEELER, Ballwin, MO (US); Christopher Andrew GUINEY, Fenton, MO (US); Natalie SHATZMAN, Webster Groves, MO (US)

(73) Assignee: MASTERCARD INTERNATIONAL INCORPORATION, Purchase, NY (US)

(21) Appl. No.: 13/622,815

(22) Filed: Sep. 19, 2012

(51) Int. Cl. G06Q 30/02

(52) U.S. Cl. 705/14.17

(57) ABSTRACT

A system and method for processing an economic benefit between friends on a social network using a consumer identifier, payment card, and plurality of friend identifiers, each friend identifier including a consumer identifier corresponding to another consumer data entry, at least one challenge including a challenge identifier, task identification, threshold number of consumers and a reward; a task identifier and a required action. Upon an indication of completion of a task by the consumer and friends or indication based on performance of the corresponding required action, the consumer and friends can share in a reward.

### FIELD

The present disclosure relates to obtaining and processing an economic benefit, specifically conferring an economic benefit to consumers in a social network upon the completion of challenges.

### BACKGROUND

Merchants and businesses employ a variety of techniques to advertise and entice consumers to transact with them. Traditional advertisements were often in the form of print newspaper or magazine ads, television ads, or radio ads that were distributed to a wide, general population. As the popularity of the Internet rose, online advertising also became more popular due to the ability to track a users browsing history and offer better targeted advertisements. Many merchants also began to use referral systems in order to draw in new consumers, with the goal that an advertisement from friends and family would be stronger than one coming from the merchant.

In recent years, social networking such as Facebook®, Twitter®, and Foursquare® have resulted in a vast increase in consumer referrals to one another. Many websites and applications may display to a consumer that associates of the consumer have purchased a specific product or deal, or that an associate has recommended a product or service. In addition, some services may offer rewards to a consumer when a referral to associates for a product or service results in a sale. However, such systems will often only reward the person making the referral, and in many instances, only require the person to make the referral and complete no other action. Meanwhile, the referred party may be required to complete a purchase or a transaction and receive no additional benefit.

Thus, there is a need for a technical solution that allows for conferring an economic benefit to all consumers in a social network through the completion of tasks by each of the consumers.

### SUMMARY

The present disclosure provides a description of exemplary technical solutions to the problem of engaging more people involved in transactions that involve a referral in the form of a system and method for obtaining and processing an economic benefit, although the claimed invention is not limited to these exemplary embodiments or to embodiments that provide the same benefits or solutions.

A method for obtaining and processing an economic benefit includes: storing, in a consumer database, a plurality of consumer data entries, wherein each consumer data entry corresponds to a consumer, and wherein each consumer data entry includes at least a consumer identifier, a payment card, and a plurality of friend identifiers, wherein each friend identifier includes a consumer identifier corresponding to another consumer data entry in the plurality of consumer data entries; storing, in a challenge database, at least one challenge, wherein each challenge includes a challenge identifier, a task identification, a threshold number of consumers, and a reward; storing, in a task database, a plurality of tasks, wherein each task includes at least a task identifier and a required action; receiving, by a receiving device, an indication of completion of a task of the plurality of tasks by the consumer, wherein the indication of completion of the task is based on performance of the corresponding required action; identifying, by a processing device, a consumer data entry of the plurality of consumer data entries corresponding to the consumer; identifying, by the processing device, a challenge of the at least one challenge, wherein the associated task identification corresponds to the task identifier associated with the indicated task; identifying, in the consumer data entry, friend identifiers of the plurality of friend identifiers that have completed the indicated task; associating, in the consumer database, the reward corresponding to the identified challenge with a payment card corresponding to each of the consumer and the identified friend identifiers if the total number of the consumer and the identified friend identifiers is at least equal to the threshold number of consumers corresponding to the identified challenge; and submitting an authorization request for a financial transaction, wherein the authorization request includes at least the payment card corresponding to the consumer and a transaction amount, and wherein the transaction amount is based on the associated reward.

A system for obtaining and processing an economic benefit includes a consumer database, a challenge database, a task database, a receiving device, a processing device, and a transmitting device. The consumer database is configured to store a plurality of consumer data entries, wherein each consumer data entry corresponds to a consumer, and wherein each consumer data entry includes at least a consumer identifier, a payment card, and a plurality of friend identifiers, wherein each friend identifier includes a consumer identifier corresponding to another consumer data entry in the plurality of consumer data entries. The challenge database is configured to store at least one challenge, wherein each challenge includes a challenge identifier, a task identification, a threshold number of consumers, and a reward. The task database is configured to store a plurality of tasks, wherein each task includes at least a task identifier and a required action. The receiving device is configured to receive an indication of completion of a task of the plurality of tasks by the consumer, wherein the indication of completion of the task is based on performance of the corresponding required action. The processing device is configured to: identify a consumer data entry of the plurality of consumer data entries corresponding to the consumer; identify a challenge of the at least one challenge, wherein the associated task identification corresponds to the task identifier associated with the indicated task; identify, in the consumer data entry, friend identifiers of the plurality of friend identifiers that have completed the indicated task; and associate, in the consumer database, the reward corresponding to the identified challenge with a payment card corresponding to each of the consumer and the identified friend identifiers if the total number of the consumer and the identified friend identifiers is at least equal to the threshold number of consumers corresponding to the identified challenge. The transmitting device is configured to submit an authorization request for a financial transaction, wherein the authorization request includes at least the payment card corresponding to the consumer and a transaction amount, and wherein the transaction amount is based on the associated reward.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a block diagram illustrating a system for obtaining and processing an economic benefit to a social network in accordance with exemplary embodiments.

FIG. 2 is a block diagram illustrating a processing server in accordance with exemplary embodiments.

FIG. 3 is a block diagram illustrating a consumer database in accordance with exemplary embodiments.

FIG. 4 is a block diagram illustrating a challenge database in accordance with exemplary embodiments.

FIG. 5 is a block diagram illustrating a task database in accordance with exemplary embodiments.

FIG. 6 is a flow diagram illustrating a method for processing and distributing an economic benefit to a social network in accordance with exemplary embodiments.

FIG. 7 is a block diagram illustrating system architecture of a computer system in accordance with exemplary embodiments.

FIG. 8 is a flow chart illustrating an exemplary method for processing and distributing an economic benefit in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Processing an Economic Benefit to a Social Network

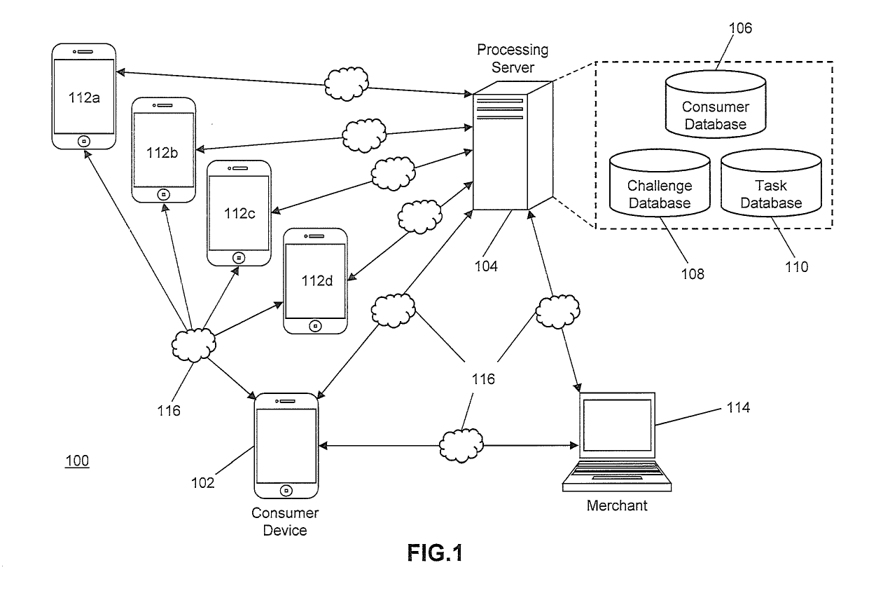

FIG. 1 illustrates a system 100 for obtaining and processing an economic benefit in a social network. Several of the components of the system 100 may communicate via a network 116. The network 116 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

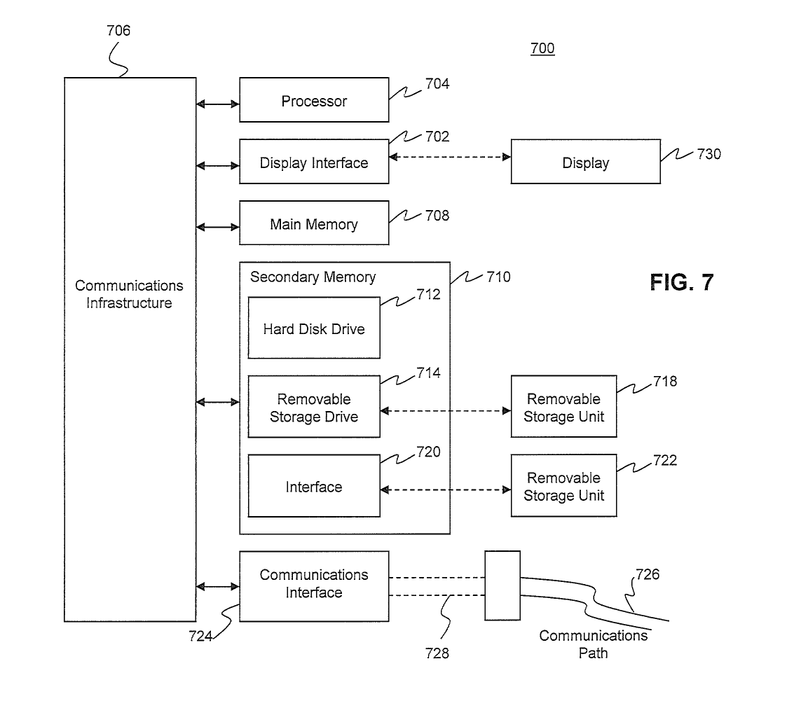

The system 100 may include a consumer device 102. The consumer device 102 may be any type of consumer device suitable for performing the functions as disclosed herein, such as a cellular phone (e.g., smart phone), laptop computer, tablet computer, or the system 700 illustrated in FIG. 7 and discussed in more detail below. The consumer device 102 may be configured to store and run (e.g., via a processing device) an application program. The consumer device 102 may (e.g., via the application program) communicate with a processing server 104 via the network 116.

The processing server 104 may include a consumer database 106, a challenge database 108, and a task database 110, each of which is discussed in more detail below. The processing server 104 may identify the consumer device 102 using the consumer database 106 and may distribute a plurality of tasks and/or challenges from the task database 110 and/or challenge database 108, respectively, to the consumer device 102. Each task, discussed in more detail below, may require a user (e.g., of the consumer device 102) to complete a specific action. A challenge, also discussed in more detail below, may require a user and a threshold number of other users to complete a specific task. Upon completion of the task by the threshold number of users, each of the users that participated in the challenge (e.g., by completing the task) may be provided an economic benefit. In one embodiment, the economic benefit may be with a merchant 114.

The consumer device 102 may be configured to display the tasks and/or challenges from the task database 110 and/or challenge database 108. The user may identify a challenge and may transmit a message (e.g., a short message service (SMS) message, electronic mail, notification within the application program, etc.) to a plurality of friends 112, illustrated in FIG. 1 as friend devices 112a, 112b, 112c, and 112d. It will be apparent to persons having skill in the relevant art that the term “friend” as used herein may refer to friends, family members, associates, acquaintances, coworkers, or any other person that may have a relationship to a user. In some embodiments, the user of the consumer device 102 may share an identified challenge via a social network, such as by posting on Facebook® or Twitter®.

### Processing Server

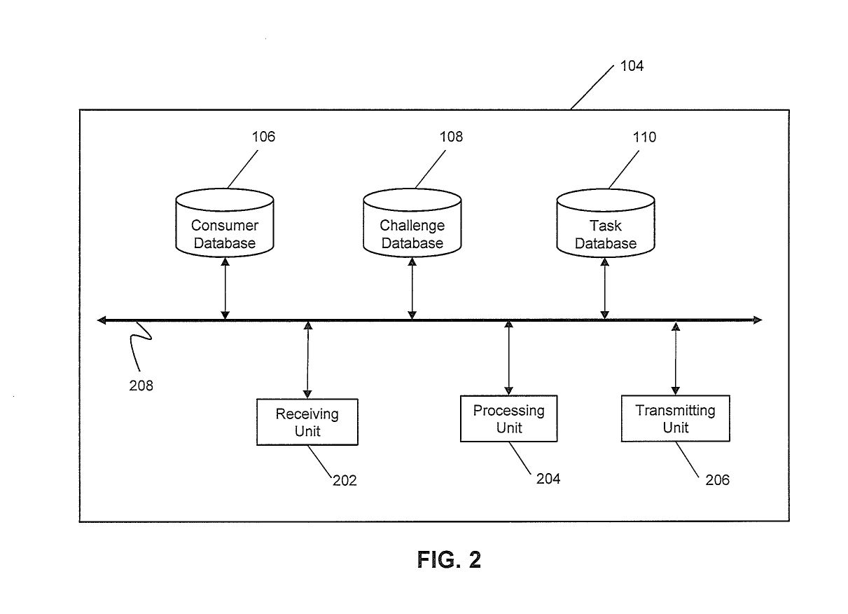

FIG. 2 illustrates an embodiment of the processing server 104. The processing server 106 may be any kind of server configured to perform the functions as disclosed herein, such as the computer system illustrated in FIG. 7 and described in more detail below. The processing server 104 may include the consumer database 106, the challenge database 108, the task database 110, a receiving unit 202, a processing unit 204, and a transmitting unit 206. Each of the components may be connected via a bus 208. Suitable types and configurations of the bus 208 will be apparent to persons having skill in the relevant art.

Data stored in the consumer database 106, the challenge database 108, and the task database 110 (the “databases”) may be stored on any type of suitable computer readable media, such as optical storage (e.g., a compact disc, digital versatile disc, blu-ray disc, etc.) or magnetic tape storage (e.g., a hard disk drive). The databases may be configured in any type of suitable database configuration, such as a relational database, a structured query language (SQL) database, a distributed database, an object database, etc. Suitable configurations and database storage types will be apparent to persons having skill in the relevant art. The databases may each be a single database, or may comprise multiple databases which may be interfaced together (e.g., physically or via a network, such as the network 116).

The receiving unit 202 may be configured to receive requests for data from a consumer device, such as the consumer device 102 or friend devices 112. The request for data may be transmitted via an application program stored and executed on the consumer device 102. The processing unit 204 may be configured to identify tasks and/or challenges from the task database 110 and the challenge database 108 to fulfill the request. The transmitting unit 206 may be configured to transmit the identified tasks and/or challenges to the consumer device 102 in response to the request.

The receiving unit 202 may also be configured to receive indications of completed tasks. An indication of a completed task may include information to identify the consumer (e.g., in the consumer database 106) that completed the task and may be transmitted by the consumer device 102, a separate device associated with the consumer, the merchant 114, or any other device or entity as will be apparent to persons having skill in the relevant art. The processing unit 204 may be configured to identify a task in the task database 110 corresponding to the received indication of completion and update the task database 110 and/or consumer database 106 to reflect the completion of the task by the user.

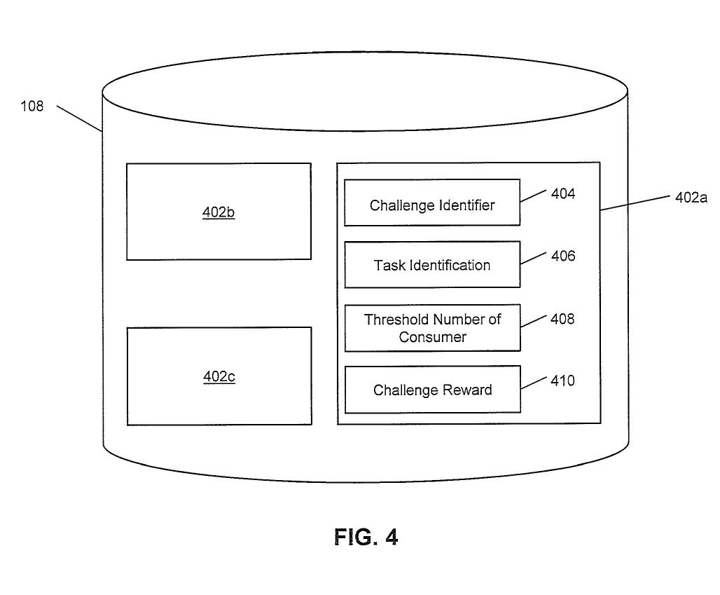

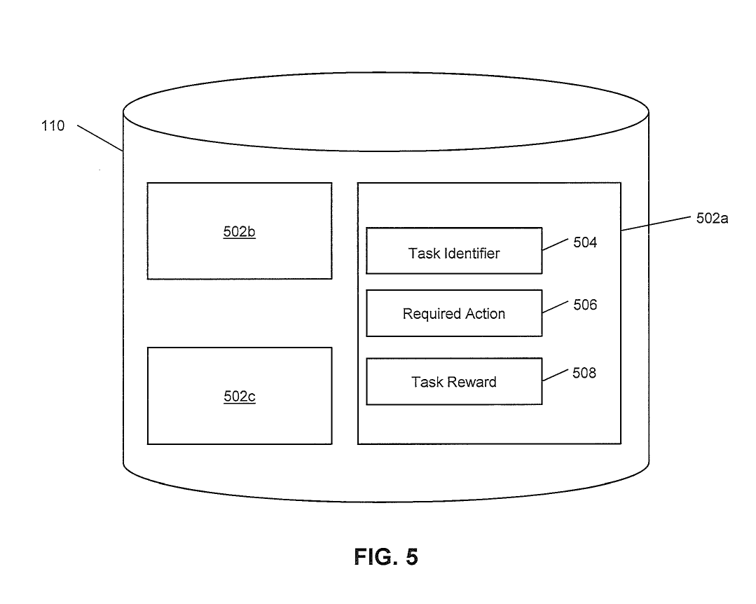

In some embodiments, the processing unit 204 may be configured to process a reward for the completed task, discussed in more detail below. The processing unit 204 may also be configured to identify, in the challenge database 108, a challenge corresponding to the completed task. The processing unit 204 may identify, in the challenge database 108 and/or consumer database 106 friend identifiers associated with the user that completed the task and may identify if a threshold number of friends corresponding to the friend identifiers also completed the task. If the threshold number is met or exceeded, then the processing unit 204 may confer an economic benefit to the user and each of the friends, such as by associating a financial account of the user and friends with a discount or submitting (e.g., via the transmitting unit 206) an authorization request for a transaction where the transaction amount is based on a reward for completion of the challenge. Challenges and tasks are discussed in more detail below with respect to FIGS. 4 and 5, respectively.

### Consumer Database

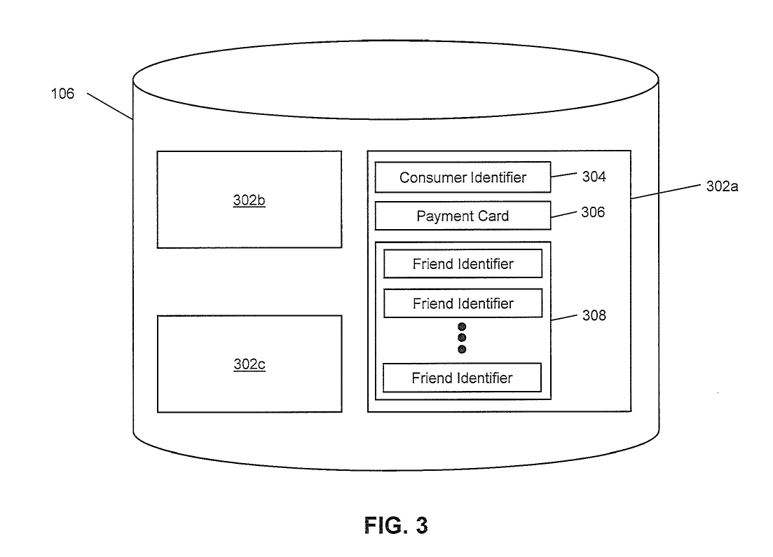

FIG. 3 illustrates an exemplary embodiment of the consumer database 106. The consumer database 106 may include a plurality of consumer datasets 302, illustrated as consumer datasets 302a, 302b, and 302c. Each consumer dataset 302 may include at least a consumer identifier 304, a payment card 306, and a plurality of friend identifiers 308. In some embodiments, each consumer dataset 302 may further include completion or progress information for tasks and/or challenges.

The consumer identifier 304 may be a unique value associated with a consumer, such as for the purposes of identifying a unique consumer dataset 302 associated with the consumer. The consumer identifier 304 may be, for example, a personal identification number (PIN), a financial account number, an e-mail address, a phone number, etc. Types of values suitable for use of the consumer identifier 304 will be apparent to persons having skill in the relevant art.

The payment card 306 may be a payment card number or other payment card details for a payment card that is issued to the consumer associated with the consumer dataset 302. In some embodiments, the payment card 306 may be any type of financial account for the purposes of disbursement of a reward, such as a checking account, a savings account, an investment account, etc.

The plurality of friend identifiers 308 may include consumer identifiers 304 for friends (e.g., acquaintances, associates, family, etc.) of the consumer. In one embodiment, each consumer dataset 302 may include a single plurality of friend identifiers 308. In other embodiments, the consumer dataset 302 may include a plurality of friend identifiers 308 associated with each challenge (e.g., available, undertaken, etc.) of the consumer. For example, the consumer may be attempting to complete one challenge with coworkers, but may be attempting to complete another challenge with friends and family, and therefore may have a different set of friend identifiers 308 for each challenge. Friend identifiers 308 may be set by the consumer, may require acceptance of the corresponding friend, may be automatically identified via a social network (e.g., Facebook® friends), automatically identified via e-mail contacts, etc.

### Challenges and Tasks

FIG. 4 illustrates an exemplary embodiment of the challenge database 108. The challenge database 108 may include a plurality of challenges 402, illustrated as the challenges 402a, 402b, and 402c. Each of the challenges 402 may include at least a challenge identifier 404, a task identification 406, a threshold number of consumers 408, and a challenge reward 410.

The challenge identifier 404 may be a unique value associated with the challenge for the purposes of identifying the unique challenge 402. The challenge identifier 404 may be randomly generated, may be identified from a list of unique values, etc. In one embodiment, each challenge identifier 404 may be identified by the processing server 104. In another embodiment, the challenge identifier 404 for a challenge 402 may be set by an entity for which the challenge reward 410 applies, such as the merchant 114. For example, the merchant 114 may set the challenge identifier 404 to be a value including the name of the merchant 114 or the name of a discounted product to which the challenge reward 410 applies. In some embodiments, the challenge identifier 404 may be a name. In other embodiments, each challenge 402 may further include a name.

The task identification 406 may include at least one task identifier, discussed in more detail below, for a task in the task database 110, which may be the subject of the corresponding challenge. The threshold number of consumers 408 may be a number of consumers that must complete the identified task in order to earn the challenge reward 410. The threshold number of consumers 408 may be as little as two, but may be any value as will be apparent to persons having skill in the relevant art. For example, one challenge may require that three friends complete the identified task, whereas another challenge may require that hundreds of coworkers of a large business each complete the identified task to earn the reward.

The challenge reward 410 may be a reward that is distributed to each of the consumers that completed the task identified in the task identification 406. In an exemplary embodiment, only those consumers who actually completed the task may receive the challenge reward 410. For example, if a consumer and ten friends are attempting a challenge with a threshold number of consumers of five, and seven consumers finish the identified task, then only those seven may receive the challenge reward 410. In some embodiments, each challenge may include a predetermined period of time or expiration date during which the identified task must be completed, such that if the threshold number of consumers 408 is met, additional consumers participating in the challenge 402 may complete the identified task and receive the challenge reward 402. In one embodiment, if the predetermined period of time expires or expiration date is passed, the challenge 402 may remain open but be modified. For example, the threshold number of consumers 408 may be increased, the challenge reward 410 may be changed or decreased, the task to be completed may be changed or modified, or additional tasks may be required to be completed.

Rewards offered as the challenge reward 410 may be any type of reward, such as a coupon, discount, deal, etc. for any type of product or service. For example, the challenge reward 410 may be a discount at the merchant 114 (e.g., $5 off any purchase, $10 off a purchase of $20 or more, 10% off any purchase, 20% off any one item, etc.), may be a deal at the merchant 114 or for a particular product by a retailer (e.g., buy one get one free, buy two get the third free, buy one get one half off, etc.), or for any other type of reward, such as a pass for an instant table at a restaurant without having to wait.

Each challenge 402 may further include a plurality of groups of consumer identifiers 404 in order to track progress of the challenge 402. For example, if each challenge 402 has a separate group of consumers trying to complete it (e.g., as opposed to a consumer and a single set of friends for all challenges), the challenge 402 may include that group of consumer identifiers 404 as well as other groups of consumer identifiers 404 each of whom are trying to complete the challenge. In some instances, the challenge may also include an indication of the completion of the identified task for each consumer identifier 404 in the group of consumer identifiers 404.

FIG. 5 illustrates an exemplary embodiment of the task database 110. The task database 110 may include a plurality of tasks 502, illustrated as the tasks 502a, 502b, and 502c. Each task 502 may include at least a task identifier 504 and a required action 506. In some embodiments, each task 502 may also include a task reward 508.

The task identifier 504 may be a unique value associated with the challenge for the purposes of identifying the unique task 502. The task identifier 504 may be randomly generated, may be identified from a list of unique values, etc. In one embodiment, each task identifier 504 may be identified by the processing server 104. In another embodiment, the task identifier 504 for a task 502 may be set by an entity for which the task reward 508 or required action 506 applies, such as the merchant 114. For example, the merchant 114 may set the task identifier 504 to be a value including the name of the merchant 114, the name of a discounted product to which the task reward 508 applies, or related to the required action 506. In some embodiments, the task identifier 504 may be a name. In other embodiments, each task 502 may further include a name.

The required action 506 may be an action to be performed by a consumer in order to fulfill the task 502. Required actions 506 may include, for example, buying a specific product, transacting at a specific merchant (e.g., the merchant 114), posting a tweet on Twitter® (e.g., using a specific hash tag), posting to a Facebook® timeline (e.g., and including the name of a product or merchant 114), liking a merchant, retailer, or product Facebook® page, posting a picture to Facebook®, Twitter®, or Instagram®, checking in to a specific location on Facebook® or Foursquare®, using a specific type of payment card for a transaction, using a specific type of payment method (e.g., PayPass) for at least one transaction, etc. The required action 506 may also include visiting a physical location (e.g., of the merchant 114), which may be verified using the global positioning system (GPS), connecting to a wireless network, scanning a machine readable code (e.g., a QR code) at the location with the consumer device 102, receiving an ultrasound transmission with the consumer device 102, etc. In some embodiments, the required action 506 may include multiple actions, such as scanning a QR code on a poster at a merchant and then spending at least $5 at the merchant. Additional types of actions that may be suitable as the required action 506 will be apparent to persons having skill in the relevant art.

The task reward 508 may be a reward that is distributed to a consumer upon completion of the required action 506. It will be apparent to persons having skill in the relevant art that the task reward 508 may be optional. For example, a reward may not be offered for completion of the task 502 as the consumer would receive the challenge reward 410 for the corresponding challenge 402 when the threshold number of consumers 408 has been met or exceed. In some embodiments, the task reward 508 may be included as additional motivation for consumers in a social network to complete the challenge 402.

The task reward 508 may be any type of reward as discussed above with relation to the challenge reward 410. The task reward 508 may also be related to the required action 506. For example, the required action 506 may be to scan a QR code displayed on a poster at the merchant location, and the task reward 508 may be a free copy of the displayed poster. Suitable rewards to serve as the task reward 508 will be apparent to persons having skill in the relevant art.

### Method for Distributing and Processing Challenge Rewards

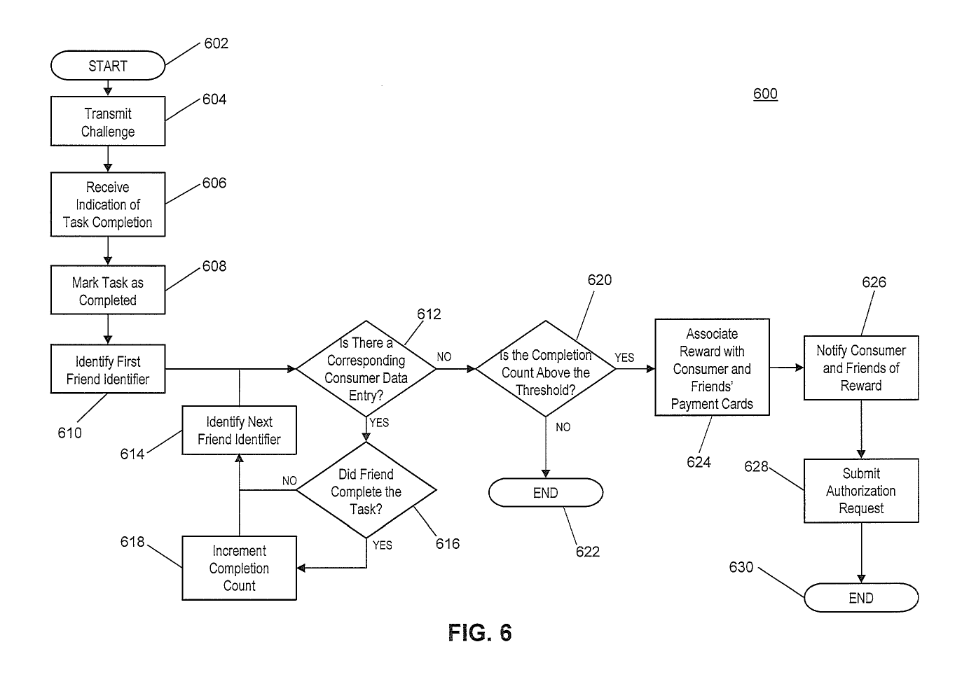

FIG. 6 illustrates a method 600 for distributing and processing challenge rewards such as an economic benefit to consumers that complete a challenge.

At step 602, the method 600 starts. At step 604, the transmitting unit 206 of the processing server 104 transmits a challenge 402 to the consumer device 102. In one embodiment, the challenge 402 is transmitted to an application program stored and executed on the consumer device 102. The application program may be configured to display the challenge 402 to the user and may be further configured to allow the user to share the challenge 402 with other users (e.g., friends in the plurality of friend identifiers 308), such as via a social network service.

At step 606, the receiving unit 202 of the processing server 104 may receive an indication of completion of the corresponding task 502 identified in the task identification 406. The indication of completion may include the results of the required action 506 (e.g., proof of purchase, transmission resulting from a scanned QR code, etc.) or may include the task identifier 504 and the consumer identifier 304 of the consumer that completed the task. In embodiments where the task 502 includes a task reward 508, then the processing unit 204 may process the task reward 508.

At step 608, the processing unit 204 may mark the task 502 as completed. In one embodiment, the completion may be marked in the corresponding consumer dataset 302 in the consumer database 108. In another embodiment, the completion may be marked in the corresponding challenge 402 in the challenge database 108 (e.g., in a group of a plurality of consumer identifiers that includes the consumer). In yet another embodiment, completion of the task may be marked in the task 502 in the task database 110.

At step 610, the processing unit 204 may identify a first friend identifier of the plurality of friend identifiers 308 of the consumer dataset 302 corresponding to the consumer that completed the task. It will be apparent to persons having skill in the relevant art that in embodiments where each challenge 402 may include a different group of friends, the processing unit 204 may identify friend identifiers in the respective group. At step 612, the processing unit 204 may identify if there is a consumer dataset 302 corresponding to the identified friend identifier. If there is, then, at step 614, the processing unit 204 may identify if the friend completed the task 502. If the friend completed the task 502, then the processing unit 204 may increment a count on the number of consumers in the group to have completed the task 502.

Once the count has been incremented, or if the friend did not complete the task, then the method 600 may proceed to step 614. At step 614, the processing unit 204 may identify the next friend identifier in the plurality of friend identifiers 308. The method 600 may return to step 612 to determine if there is a corresponding consumer dataset 302. If there is not a corresponding consumer dataset 302 (e.g., because all of the friends in the plurality of friends have been identified and processed), then, at step 620, the processing unit 204 may identify if the completion count is above the threshold number of consumers 408 of the challenge 402. If the count is not above the threshold number of consumers 408 then the method 600 will end at step 622, where the challenge 402 may continue (e.g., until expiration or another friend in the group completes the identified task 502).

If the count is above the threshold number of consumers 408, then, at step 624, the processing unit 204 may associate the challenge reward 410 with the payment card 306 of the consumer and each friend corresponding to each of the plurality of friend identifiers 308. At step 626, the transmitting unit 206 may transmit a notification of the challenge reward 410 to the consumer device 102 and friend devices 112 that completed the challenge 402. In one embodiment, the notification may be transmitted to the application program on the consumer device 102. In other embodiments, the notification may be transmitted via short message service (SMS) message, electronic mail, traditional mail, etc. In one embodiment, the challenge reward 410 or a method of redemption of the challenge reward 410 may be transmitted to the consumer and friends as a physical media (e.g., a coupon, such as one including a bar code or QR code).

At step 628, the transmitting unit 206 may submit an authorization request for a financial transaction on behalf of the consumer. The authorization request may include a transaction amount, which may be based on the challenge reward 410. For example, if the consumer transacts with the merchant 114 using the payment card 306 included in the consumer dataset 302 corresponding to the consumer, then the processing server 104 may identify the challenge reward 410 associated with the consumer and may apply it to the transaction by modifying the transaction amount based on the challenge reward 410.

### Computer System Architecture

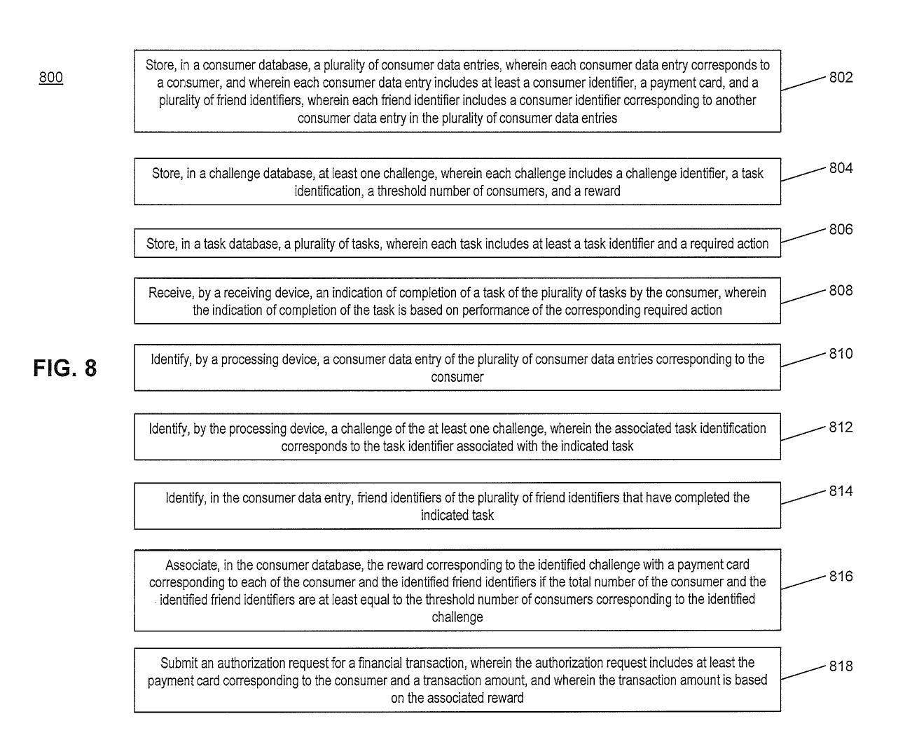

FIG. 7 illustrates a computer system 700 in which embodiments of the present disclosure, or portions thereof, may be implemented as computer-readable code. For example, the consumer device 102, the processing server 104, the friend devices 112, and the merchant 114 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 6 and 8.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communication infrastructure 706, such as a bus, message queue, network (e.g., the network 116), multi-core message-passing scheme, etc. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive, the removable storage unit 718 may be a floppy disk. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

Computer program medium and computer usable medium may refer to memories, such as the main memory 708 and secondary memory 710, which may be memory semiconductors (e.g. DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 6 and 8, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

### Exemplary Method for Obtaining and Processing an Economic Benefit

FIG. 8 illustrates a method 800 for obtaining and processing an economic benefit.

In step 802, a plurality of consumer data entries (e.g., consumer datasets 302) may be stored in a consumer database (e.g., the consumer database 106), wherein each consumer data entry corresponds to a consumer, and wherein each consumer data entry includes at least a consumer identifier (e.g., the consumer identifier 304), a payment card (e.g., the payment card 306), and a plurality of friend identifiers (e.g., the plurality of friend identifiers 308), wherein each friend identifier includes a consumer identifier corresponding to another consumer data entry in the plurality of consumer data entries. In one embodiment, each consumer data entry may further include an indication of completed or in progress tasks and/or challenges.

In step 804, at least one challenge (e.g., challenge 402) may be stored in a challenge database (e.g., the challenge database 108), wherein each challenge includes a challenge identifier (e.g., challenge identifier 404), a task identification (e.g., task identification 406), a threshold number of consumers (e.g., threshold number of consumers 408), and a reward (e.g., challenge reward 410). In one embodiment, each challenge may further include at least one group of consumer identifiers and an indication of completion of the task corresponding to the task identification for each consumer identifier in the group of consumer identifiers. In one embodiment, the threshold number of consumers is at least three.

In step 806, a plurality of tasks (e.g., tasks 502) may be stored in a task database (e.g., the task database 110), wherein each task includes at least a task identifier (e.g., task identifier 504) and a required action (e.g., the required action 506). In one embodiment, the required action may be at least one of: scanning a machine readable code (e.g., a bar code, such as a QR code), sending a SMS message, transmitting a geographic location, posting to a social network, using a payment card, taking a picture, and using an electronic wallet. In some embodiments, each task may further include a task reward. In one embodiment, the task database and the challenge database may be a single database.

In step 808, a receiving device (e.g., the receiving unit 202) may receive an indication of completion of a task of the plurality of tasks by the consumer, wherein the indication of completion of the task is based on performance of the corresponding required action. Then, in step 810, a processing device (e.g., the processing unit 204) may identify a consumer data entry of the plurality of consumer data entries corresponding to the consumer. The processing device may also identify, in step 812, a challenge of the at least one challenge, wherein the associated task identification corresponds to the task identifier associated with the indicated task.

In step 814, the processing device may identify, in the consumer data entry, friend identifiers of the plurality of friend identifiers that have completed the indicated task. Then, in step 816, the reward corresponding to the identified challenged may be associated, in the consumer database, with a payment card corresponding to each of the consumer and the identified friend identifiers if the total number of the consumer and the identified friend identifiers is at least equal to the threshold number of consumers corresponding to the identified challenge. In step 818, an authorization request for a financial transaction may be submitted, wherein the authorization request includes at least the payment card corresponding to the consumer and a transaction amount, and wherein the transaction amount is based on the associated reward.

In one embodiment, each challenge of the at least one challenge may further include a merchant identifier, and the authorization request may further include the merchant identifier corresponding to the identified challenge. In another embodiment, each challenge of the at least one challenge may further include a required transaction amount, wherein the transaction amount is at least equal to the required transaction amount.

Techniques consistent with the present disclosure provide, among other features, systems and methods for obtaining and processing an economic benefit. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for obtaining and processing an economic benefit, comprising:
storing, in a consumer database, a plurality of consumer data entries, wherein each consumer data entry corresponds to a consumer, and wherein each consumer data entry includes at least a consumer identifier, a payment card, and a plurality of friend identifiers, wherein each friend identifier includes a consumer identifier corresponding to another consumer data entry in the plurality of consumer data entries;
storing, in a challenge database, at least one challenge, wherein each challenge includes a challenge identifier, a task identification, a threshold number of consumers, and a reward;
storing, in a task database, a plurality of tasks, wherein each task includes at least a task identifier and a required action;
receiving, by a receiving device, an indication of completion of a task of the plurality of tasks by the consumer, wherein the indication of completion of the task is based on performance of the corresponding required action;
identifying, by a processing device, a consumer data entry of the plurality of consumer data entries corresponding to the consumer;
identifying, by the processing device, a challenge of the at least one challenge, wherein the associated task identification corresponds to the task identifier associated with the indicated task;
identifying, in the consumer data entry, friend identifiers of the plurality of friend identifiers 308 that have completed the indicated task;
associating, in the consumer database, the reward corresponding to the identified challenge with a payment card corresponding to each of the consumer and the identified friend identifiers if the total number of the consumer and the identified friend identifiers are at least equal to the threshold number of consumers corresponding to the identified challenge; and
submitting an authorization request for a financial transaction, wherein the authorization request includes at least the payment card corresponding to the consumer and a transaction amount, and wherein the transaction amount is based on the associated reward.

2. The method of claim 1, wherein the task database and the challenge database are a single database.

3. The method of claim 1, wherein each challenge further includes a merchant identifier and wherein the authorization request further includes the merchant identifier corresponding to the identified challenge.

4. The method of claim 1, wherein each challenge further includes a required transaction amount and wherein the transaction amount is at least equal to the required transaction amount.

5. The method of claim 1, wherein the required action is at least one of: scanning a machine-readable code, sending a short message service (SMS) message, transmitting a geographic location, posting to a social network, using a payment card, taking a picture, and using an electronic wallet.

6. The method of claim 1, wherein the threshold number of consumers is at least three.

7. A system for obtaining and processing an economic benefit, comprising:
a consumer database configured to store a plurality of consumer data entries, wherein each consumer data entry corresponds to a consumer, and wherein each consumer data entry includes at least a consumer identifier, a payment card, and a plurality of friend identifiers, each friend identifier including a consumer identifier corresponding to another consumer data entry in the plurality of consumer data entries;
a challenge database configured to store at least one challenge, wherein each challenge includes a challenge identifier, a task identification, a threshold number of consumers, and a reward;
a task database configured to store a plurality of tasks, wherein each task includes at least a task identifier and a required action;
a receiving device configured to receive an indication of completion of a task of the plurality of tasks by the consumer, wherein the indication of completion of the task is based on performance of the corresponding required action;
a processing device configured to
identify a consumer data entry of the plurality of consumer data entries corresponding to the consumer,
identify a challenge of the at least one challenge, wherein the associated task identification corresponds to the task identifier associated with the indicated task,
identify, in the consumer data entry, friend identifiers of the plurality of friend identifiers that have completed the indicated task, and
associate, in the consumer database, the reward corresponding to the identified challenge with a payment card corresponding to each of the consumer and the identified friend identifiers if the total number of the consumer and the identified friend identifiers are at least equal to the threshold number of consumers corresponding to the identified challenge; and
a transmitting device configured to submit an authorization request for a financial transaction, wherein the authorization request includes at least the payment card corresponding to the consumer and a transaction amount, and wherein the transaction amount is based on the associated reward.

8. The system of claim 7, wherein the task database and the challenge database are a single database.

9. The system of claim 7, wherein each challenge further includes a merchant identifier and wherein the authorization request further includes the merchant identifier corresponding to the identified challenge.

10. The system of claim 7, wherein each challenge further includes a required transaction amount and wherein the transaction amount is at least equal to the required transaction amount.

11. The system of claim 7, wherein the required action is at least one of: scanning a machine-readable code, sending a short message service (SMS) message, transmitting a geographic location, posting to a social network, using a payment card, taking a picture, and using an electronic wallet.

12. The system of claim 7, wherein the threshold number of consumers is at least three.
